(19) United States
(12) Patent Application Publication
(10) Pub. No.: US 2021/0311420 A1
(43) Pub. Date: Oct. 7, 2021

(54) FIXING DEVICE, IMAGE FORMING APPARATUS, FIXING METHOD, AND IMAGE FORMING METHOD

(71) Applicant: Ricoh Company, Ltd., Tokyo (JP)

(72) Inventors: Hiroshi YOSHINAGA, Chiba (JP); Takamasa HASE, Tokyo (JP)

(73) Assignee: Ricoh Company, Ltd., Tokyo (JP)

(21) Appl. No.: 17/195,899

(22) Filed: Mar. 9, 2021

(30) Foreign Application Priority Data
Apr. 2, 2020 (JP) 2020-066403

(51) Int. Cl. G03G 15/20

(52) U.S. Cl. CPC G03G 15/2025

(57) ABSTRACT

A fixing device includes a fixing rotator that rotates in a rotation direction and a pressure rotator that presses against the fixing rotator to form a nip between the fixing rotator and the pressure rotator, through which a recording medium bearing a toner image formed with glitter toner is conveyed. A brush includes a loop that contacts a surface of the fixing rotator.

### CROSS-REFERENCE TO RELATED APPLICATION

This patent application is based on and claims priority pursuant to 35 U.S.C. § 119(a) to Japanese Patent Application No. 2020-066403, filed on Apr. 2, 2020, in the Japan Patent Office, the entire disclosure of which is hereby incorporated by reference herein.

### BACKGROUND

### Technical Field

Exemplary aspects of the present disclosure relate to a fixing device, an image forming apparatus, a fixing method, and an image forming method.

### Discussion of the Background Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses may include a fixing device that fixes an image on a recording medium. The image may be formed with metal powder. For example, the image is formed with metallic color toner (e.g., metallic toner) so that the image having a metallic color such as gold and silver is formed on the recording medium.

For example, the metallic color toner is produced by mixing a metallic pigment (e.g., metal powder) with a binder resin, a colorant, and a compounding agent. The binder resin is made of a synthetic resin such as styrene and acryl. The metallic pigment is made of a material that has a relatively great particle diameter such as silver powder and metallic aluminum powder.

The metallic pigment made of the silver powder or the like is flat, squamous, disk-shaped, or spherical. An average particle diameter of the metallic pigment made of the silver powder or the like is greater than an average particle diameter of each of yellow, magenta, cyan, and black toners used regularly. The metallic pigment is rigid and has a sharp edge. Hence, the metallic pigment may damage a fixing member of the fixing device. A scratch produced on the fixing member by the metallic pigment contained in an image on a preceding recording medium may be transferred onto an image on a succeeding recording medium, degrading quality of the image fixed on the succeeding recording medium.

### SUMMARY

This specification describes below an improved fixing device. In one embodiment, the fixing device includes a fixing rotator that rotates in a rotation direction and a pressure rotator that presses against the fixing rotator to form a nip between the fixing rotator and the pressure rotator, through which a recording medium bearing a toner image formed with glitter toner is conveyed. A brush includes a loop that contacts a surface of the fixing rotator.

This specification further describes an improved image forming apparatus. In one embodiment, the image forming apparatus includes the fixing device described above.

This specification further describes an improved fixing method. In one embodiment, the fixing method includes rotating a fixing rotator, conveying a recording medium bearing a toner image formed with glitter toner through a nip formed between the fixing rotator and a pressure rotator, causing a loop of a brush to contact a surface of the fixing rotator, and causing the loop of the brush to remove the glitter toner adhered from the recording medium to the fixing rotator from the fixing rotator.

This specification further describes an improved image forming method. In one embodiment, the image forming method includes forming a toner image on a recording medium with glitter toner, rotating a fixing rotator, conveying the recording medium bearing the toner image through a nip formed between the fixing rotator and a pressure rotator, causing a loop of a brush to contact a surface of the fixing rotator, and causing the loop of the brush to remove the glitter toner adhered from the recording medium to the fixing rotator from the fixing rotator.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure, illustrating an entire construction and operations of the image forming apparatus;

FIG. 2 is a schematic cross-sectional view of a fixing device according to a first embodiment of the present disclosure, that is incorporated in the image forming apparatus depicted in FIG. 1, illustrating a construction of the fixing device;

FIG. 3A is a schematic cross-sectional view of a comparative fixing device;

FIG. 3B is a schematic cross-sectional view of the comparative fixing device depicted in FIG. 3A, illustrating a removal method for removing a glitter pigment from a surface of a fixing belt incorporated in the comparative fixing device;

FIG. 4A is a schematic cross-sectional view of the fixing device depicted in FIG. 2, illustrating a brush incorporated therein;

FIG. 4B is a schematic cross-sectional view of the fixing device depicted in FIG. 4A, illustrating a removal method for removing the glitter pigment from the surface of the fixing belt incorporated in the fixing device;

FIG. 4C is a schematic cross-sectional view of the fixing device depicted in FIG. 4A, illustrating the brush that catches the glitter pigment;

FIG. 5A is a schematic cross-sectional view of a fixing device according to a second embodiment of the present disclosure, that is installable in the fixing device depicted in FIG. 2;

FIG. 5B is a schematic cross-sectional view of the fixing device depicted in FIG. 5A, illustrating a removal method for removing the glitter pigment from the surface of the fixing belt incorporated in the fixing device;

FIG. 5C is a schematic cross-sectional view of the fixing device depicted in FIG. 5A, illustrating a brush that catches the glitter pigment;

FIG. 6 is a schematic cross-sectional view of a fixing device according to a third embodiment of the present disclosure, that is installable in the fixing device depicted in FIG. 2;

FIG. 7 is a schematic cross-sectional view of a fixing device according to a fourth embodiment of the present disclosure, that is installable in the fixing device depicted in FIG. 2;

FIG. 8 is a block diagram of the image forming apparatus depicted in FIG. 1;

FIG. 9 is a flowchart illustrating processes of a fixing method performed by the fixing devices depicted in FIGS. 4A, 5A, 6, and 7; and

FIG. 10 is a flowchart illustrating processes of an image forming method performed by the image forming apparatus depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

A description is provided of toner used in fixing devices according to embodiments of the present disclosure.

The toner used in the fixing devices according to the embodiments of the present disclosure contains at least a binder resin and a platy pigment contained in the binder resin.

The platy pigment has an average particle diameter in a range of from 10 μm to 25 μm and an aspect ratio in a range of from 20 to 125. The platy pigment is treated with silica coating and includes a surface silica coat layer.

The toner attains an improved glitter property in a broad fixing temperature range.

The toner for electrophotography, that is used in the fixing devices according to the embodiments of the present disclosure and hereinafter referred to as toner also, contains at least the binder resin and the platy pigment. The toner further contains a release agent and other component as needed. The toner used in the fixing devices according to the embodiments of the present disclosure has the glitter property and is hereinafter referred to as toner or glitter toner. The glitter property of the toner defines a visually recognized glitter of metallic luster of a toner image formed with the toner.

A description is provided of the binder resin.

The binder resin is not limited as long as the binder resin dissolves in an organic solvent used. The binder resin is selected properly from regularly used resins. For example, a polyester resin is preferable.

A description is provided of the polyester resin.

As the polyester resin, materials prepared by polycondensation of general alcohol and acid are used.

For example, the alcohol includes diol such as polyethylene glycol, diethylene glycol, triethylene glycol, 1,2-propylene glycol, 1,3-propylene glycol, 1,4-propylene glycol, neopentyl glycol, and 1,4-butene diol. The alcohol further includes etherification bisphenol such as 1,4-bis (hydroxy methyl) cyclohexane, bisphenol A, hydrogenated bisphenol A, polyoxy ethylenation bisphenol A, and polyoxy propylenation bisphenol A. The alcohol further includes a divalent alcohol monomer prepared by substituting those with a saturation hydrocarbon group or an unsaturation hydrocarbon group having a carbon number in a range of from 3 to 22. The alcohol further includes other divalent alcohol monomer. The alcohol further includes a trivalent or more high alcohol monomer such as sorbitol, 1,2,3,6-hexanetetrol, 1,4-sorbitan, pentaerythritol dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

For example, carboxylic acid used to prepare the polyester resin includes monocarboxylic acid such as palmitic acid, stearic acid, and oleic acid. The carboxylic acid further includes maleic acid, fumaric acid, mesaconic acid, citraconic acid, terephthalic acid, cyclohexanedicarboxylic acid, succinic acid, adipic acid, sebacic acid, malonic acid, and a divalent organic acid monomer prepared by substituting those with a saturation hydrocarbon group or an unsaturation hydrocarbon group having a carbon number in a range of from 3 to 22. The carboxylic acid further includes anhydride of those acids. The carboxylic acid further includes a dimer of lower alkyl ester and linoleic acid. The carboxylic acid further includes 1,2,4-benzene tricarboxylic acid, 1,2,5-benzene tricarboxylic acid, 2,5,7-naphthalenetricarboxylic acid, 1,2,4-naphthalenetricarboxylic acid, 1,2,4-butane tricarboxylic acid, 1,2,5-hexane tricarboxylic acid, 1,3-dicarboxylic-2-methyl-2-methylene carboxypropane, tetra (methylene carboxyl) methane, 1,2,7,8-octane tetracarboxylic acid enbol trimer acid, and multivalent (e.g., trivalent or more) carboxylic acid monomer such as anhydride of those acids.

The polyester resin contained in the binder resin preferably has a weight average molecular weight (Mw) in a range of from 9,500 to 30,000 and a number average molecular weight (Mn) in a range of from 2,100 to 2,300.

A description is provided of other binder resin.

The toner may contain other binder resin other than the polyester resin. For example, other binder resin includes an epoxy resin, a polyurethane resin, a polyamide resin, and a styrene acryl copolymer. Among those resins, a single resin may be used solely or two or more resins may be combined.

A description is provided of the platy pigment.

The platy pigment preferably has an average particle diameter in a range of from 10 μm to 25 μm and, more preferably, in a range of from 13 μm to 21 μm. If a pigment having an average particle diameter smaller than 10 μm is used, it may be difficult to align particles of the pigment having the glitter property when a toner image is fixed on a recording medium. Additionally, a gap may generate between the particles of the pigment in the toner image easily, degrading the glitter property.

If a pigment having an average particle diameter greater than 25 μm is used, particles of the pigment may overlap when a toner image is fixed on a recording medium, degrading the glitter property.

The platy pigment preferably has an aspect ratio obtained by dividing a particle diameter by a thickness, that is in a range of from 20 to 125 and, more preferably, in a range of from 40 to 100. If a pigment having an aspect ratio obtained by dividing a particle diameter by a thickness, that is smaller than 20, is used, the pigment may be substantially spherical, degrading the glitter property. If a pigment having an aspect ratio obtained by dividing a particle diameter by a thickness, that is greater than 125, is used, the pigment may bend when a toner image is fixed on a recording medium, degrading the glitter property.

The platy pigment is treated with silica coating and includes the surface silica coat layer. If a pigment not treated with silica coating is used, bending of the pigment may increase when a toner image is fixed on a recording medium, degrading the glitter property. Types of the platy pigment are not limited and are selected properly depending on a purpose. For example, the TCR series manufactured by Toyo Aluminium K.K. is used.

A content of the platy pigment with respect to the toner is preferably in a range of from 3 parts by weight to 11 parts by weight with respect to 100 parts by weight of the toner and, more preferably, in a range of from 5 parts by weight to 11 parts by weight. Whether the platy pigment has the surface silica coat layer or not is observed by performing measurement by energy dispersive X-ray spectroscopy (EDS) with the scanning electron microscope Zeiss Ultra 55 manufactured by Carl Zeiss Co., Ltd. According to the embodiments of the present disclosure, the platy pigment is preferably coated with the surface silica coat layer having a thickness of about 0.02 μm.

A method for producing an aluminum pigment used in the embodiments of the present disclosure is not limited and may be a general method. For example, a ball mill or an attritor mill crushes aluminum powder with a grinding aid such as fatty acid in the presence of a grinding medium. Thus, the aluminum pigment having an arbitrary particle diameter and an arbitrary thickness is obtained.

The following describes a method for coating the obtained aluminum pigment with silica as an example. The aluminum pigment is dissolved in propylene glycol monomethyl ether, added with tetraethoxysilane, and then added with ammonia water and water and stirred, thus treated with silica coating.

A description is provided of measurement of the average particle diameter and the aspect ratio obtained by dividing the particle diameter by the thickness of the pigment.

The average particle diameter and the aspect ratio obtained by dividing the particle diameter by the thickness of each of particles of the pigment used in the embodiments of the present disclosure are measured with the scanning electron microscope Zeiss Ultra 55 manufactured by Carl Zeiss Co., Ltd., for example.

An obtained image is binarized with the image analysis software A-Zou Kun® available from Asahi Kasei Engineering Corporation, thus calculating an area of the pigment.

The average particle diameter is converted into a diameter value on a basis that the obtained value defines an area of a circle.

The thickness of the pigment is calculated as below. After the toner is dissolved in a soluble solvent (e.g., tetrahydrofuran) such that each of the particles of the pigment is oriented in an identical direction, coating film is produced on polyester film using spin coating and dried. After the coating film is embedded in a two-component mixed type epoxy resin, the coating film is flaked with the ultramicrotome ULTRACUT-S manufactured by Leica Camera AG such that the flaked coating film is perpendicular to a direction of the pigment. A cross section of the flaked coating film is observed to calculate the thickness of the pigment.

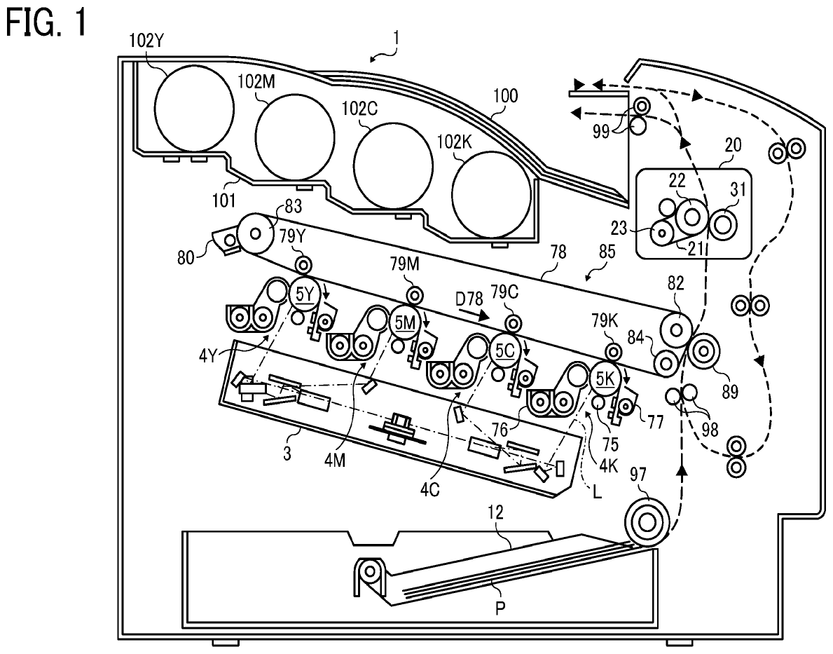

Referring to FIG. 1, a description is provided of an entire construction and operations of an image forming apparatus 1.

As illustrated in FIG. 1, the image forming apparatus 1 according to an embodiment of the present disclosure is a tandem color printer. A bottle container 101 is disposed in an upper portion of the image forming apparatus 1. Four toner bottles 102Y, 102M, 102C, and 102K containing fresh yellow, magenta, cyan, and black toners, respectively, are removably installed in the bottle container 101 so that the toner bottles 102Y, 102M, 102C, and 102K are replaced with new ones, respectively.

An intermediate transfer unit 85 is disposed below the bottle container 101. The intermediate transfer unit 85 includes an intermediate transfer belt 78. Image forming devices 4Y, 4M, 4C, and 4K that form yellow, magenta, cyan, and black toner images, respectively, are aligned and disposed opposite the intermediate transfer belt 78. One or more toner bottles filled with toner containing a pigment having the glitter property, that is, a glitter pigment, may be replaced with one or more of the four toner bottles 102Y, 102M, 102C, and 102K. Alternatively, in addition to the four toner bottles 102Y, 102M, 102C, and 102K, an image forming station exclusively used for the toner containing the glitter pigment may be disposed so that the image forming apparatus 1 includes five or more image forming devices.

Photoconductive drums 5Y, 5M, 5C, and 5K are disposed in the image forming devices 4Y, 4M, 4C, and 4K, respectively. Each of the photoconductive drums 5Y, 5M, 5C, and 5K is surrounded by a charger 75, a developing device 76, a cleaner 77, a discharger, and the like. Image forming processes (e.g., a charging process, an exposure process, a developing process, a primary transfer process, and a cleaning process) are performed on each of the photoconductive drums 5Y, 5M, 5C, and 5K, forming yellow, magenta, cyan, and black toner images on the photoconductive drums 5Y, 5M, 5C, and 5K, respectively.

A driving motor disposed inside the image forming apparatus 1 drives and rotates the photoconductive drums 5Y, 5M, 5C, and 5K clockwise in FIG. 1. The chargers 75 uniformly charge surfaces of the photoconductive drums 5Y, 5M, 5C, and 5K at charging positions where the photoconductive drums 5Y, 5M, 5C, and 5K are disposed opposite the chargers 75, respectively, in the charging process.

Thereafter, a charged portion on the surface of each of the photoconductive drums 5Y, 5M, 5C, and 5K reaches an irradiation position where an exposure device 3 irradiates each of the photoconductive drums 5Y, 5M, 5C, and 5K with a laser beam L. The laser beams L scan and expose the surfaces of the photoconductive drums 5Y, 5M, 5C, and 5K, forming electrostatic latent images according to yellow, magenta, cyan, and black image data, respectively, in the exposure process.

Thereafter, the electrostatic latent image formed on the surface of each of the photoconductive drums 5Y, 5M, 5C, and 5K reaches a developing position where each of the photoconductive drums 5Y, 5M, 5C, and 5K is disposed opposite the developing device 76. The developing devices 76 develop the electrostatic latent images into yellow, magenta, cyan, and black toner images, respectively, in the developing process.

Thereafter, the yellow, magenta, cyan, and black toner images formed on the surfaces of the photoconductive drums 5Y, 5M, 5C, and 5K, respectively, reach primary transfer positions where the photoconductive drums 5Y, 5M, 5C, and 5K are disposed opposite primary transfer bias rollers 79Y, 79M, 79C, and 79K via the intermediate transfer belt 78. At the primary transfer positions, the primary transfer bias rollers 79Y, 79M, 79C, and 79K transfer the yellow, magenta, cyan, and black toner images formed on the surfaces of the photoconductive drums 5Y, 5M, 5C, and 5K, respectively, onto the intermediate transfer belt 78 in the primary transfer process. After the primary transfer process, a slight amount of residual toner that is failed to be transferred onto the intermediate transfer belt 78 remains on each of the photoconductive drums 5Y, 5M, 5C, and 5K.

Thereafter, transfer portions on the surfaces of the photoconductive drums 5Y, 5M, 5C, and 5K, from which the yellow, magenta, cyan, and black toner images have been transferred onto the intermediate transfer belt 78, reach cleaning positions where the photoconductive drums 5Y, 5M, 5C, and 5K are disposed opposite the cleaners 77, respectively. At the cleaning positions, cleaning blades of the cleaners 77 mechanically collect the residual toner failed to be transferred onto the intermediate transfer belt 78 and remained on the surfaces of the photoconductive drums 5Y, 5M, 5C, and 5K, respectively, in the cleaning process.

Finally, cleaned portions on the surfaces of the photoconductive drums 5Y, 5M, 5C, and 5K reach discharging positions where the photoconductive drums 5Y, 5M, 5C, and 5K are disposed opposite the dischargers disposed in the image forming apparatus 1, respectively. At the discharging positions, the dischargers remove residual potential on the photoconductive drums 5Y, 5M, 5C, and 5K, respectively.

Thus, a series of image forming processes performed on the photoconductive drums 5Y, 5M, 5C, and 5K finishes.

The yellow, magenta, cyan, and black toner images formed on the photoconductive drums 5Y, 5M, 5C, and 5K, respectively, in the developing process are transferred onto the intermediate transfer belt 78 such that the yellow, magenta, cyan, and black toner images are superimposed on the intermediate transfer belt 78. Thus, a color toner image is formed on the intermediate transfer belt 78.

The intermediate transfer unit 85 includes the intermediate transfer belt 78, the four primary transfer bias rollers 79Y, 79M, 79C, and 79K, a secondary transfer backup roller 82, a cleaning backup roller 83, a tension roller 84, and an intermediate transfer belt cleaner 80. The intermediate transfer belt 78, that is, an endless belt, is stretched taut across and supported by the three rollers, that is, the secondary transfer backup roller 82, the cleaning backup roller 83, and the tension roller 84. One of the three rollers, that is, the secondary transfer backup roller 82, drives and rotates the intermediate transfer belt 78 in a rotation direction D78.

The four primary transfer bias rollers 79Y, 79M, 79C, and 79K and the photoconductive drums 5Y, 5M, 5C, and 5K sandwich the intermediate transfer belt 78 to form primary transfer nips between the photoconductive drums 5Y, 5M, 5C, and 5K and the intermediate transfer belt 78, respectively. Each of the primary transfer bias rollers 79Y, 79M, 79C, and 79K is applied with a transfer bias having a polarity opposite a polarity of charged toner.

As the intermediate transfer belt 78 rotates in the rotation direction D78, the yellow, magenta, cyan, and black toner images formed on the photoconductive drums 5Y, 5M, 5C, and 5K, respectively, successively pass through the primary transfer nips where the primary transfer bias rollers 79Y, 79M, 79C, and 79K are pressed against the photoconductive drums 5Y, 5M, 5C, and 5K via the intermediate transfer belt 78, respectively. Accordingly, the primary transfer bias rollers 79Y, 79M, 79C, and 79K primarily transfer the yellow, magenta, cyan, and black toner images formed on the surfaces of the photoconductive drums 5Y, 5M, 5C, and 5K, respectively, onto the intermediate transfer belt 78 such that the yellow, magenta, cyan, and black toner images are superimposed on the intermediate transfer belt 78.

Thereafter, the yellow, magenta, cyan, and black toner images transferred and superimposed on the intermediate transfer belt 78 reach a secondary transfer position where the intermediate transfer belt 78 is disposed opposite a secondary transfer roller 89. At the secondary transfer position, the secondary transfer backup roller 82 and the secondary transfer roller 89 sandwich the intermediate transfer belt 78 to form a secondary transfer nip between the secondary transfer roller 89 and the intermediate transfer belt 78. The secondary transfer roller 89 transfers the yellow, magenta, cyan, and black toner images formed on the intermediate transfer belt 78 onto a recording medium P conveyed to the secondary transfer nip in a secondary transfer process. After the secondary transfer process, residual toner failed to be transferred onto the recording medium P remains on the intermediate transfer belt 78.

Thereafter, a transferred portion on the intermediate transfer belt 78, from which the yellow, magenta, cyan, and black toner images have been transferred onto the recording medium P, reaches a cleaning position where the intermediate transfer belt 78 is disposed opposite the intermediate transfer belt cleaner 80. At the cleaning position, the intermediate transfer belt cleaner 80 collects the residual toner from the intermediate transfer belt 78.

Thus, a series of transfer processes performed on the intermediate transfer belt 78 finishes.

The recording medium P conveyed to the secondary transfer nip is conveyed from a sheet feeder 12 disposed in a lower portion of the image forming apparatus 1 through a sheet feeding roller 97, a registration roller pair 98, and the like.

For example, the sheet feeder 12 loads a plurality of recording media P such as transfer sheets that are layered in the sheet feeder 12. As the sheet feeding roller 97 is driven and rotated counterclockwise in FIG. 1, the sheet feeding roller 97 feeds an uppermost recording medium P to a roller nip formed between rollers of the registration roller pair 98.

The registration roller pair 98 that interrupts rotation temporarily halts the recording medium P conveyed to the registration roller pair 98 at the roller nip of the registration roller pair 98. The registration roller pair 98 resumes rotation and conveys the recording medium P to the secondary transfer nip so that the recording medium P meets the color toner image formed on the intermediate transfer belt 78 at the secondary transfer nip. The secondary transfer roller 89 transfers the color toner image onto the recording medium P, thus forming the desired color toner image on the recording medium P.

Thereafter, the recording medium P transferred with the color toner image at the secondary transfer nip is conveyed to a fixing nip of a fixing device 20. The fixing nip is formed by a fixing belt 21 and a pressure roller 31 that presses against the fixing belt 21. The fixing belt 21 and the pressure roller 31 fix the color toner image transferred on a surface of the recording medium P thereon under heat and pressure at the fixing nip.

Thereafter, the recording medium P is ejected onto an outside of the image forming apparatus 1 through a roller nip of rollers of a sheet ejecting roller pair 99. The recording medium P ejected onto the outside of the image forming apparatus 1 by the sheet ejecting roller pair 99 is stacked on a stacker 100 successively as an output.

Thus, a series of image forming processes performed by the image forming apparatus 1 finishes.

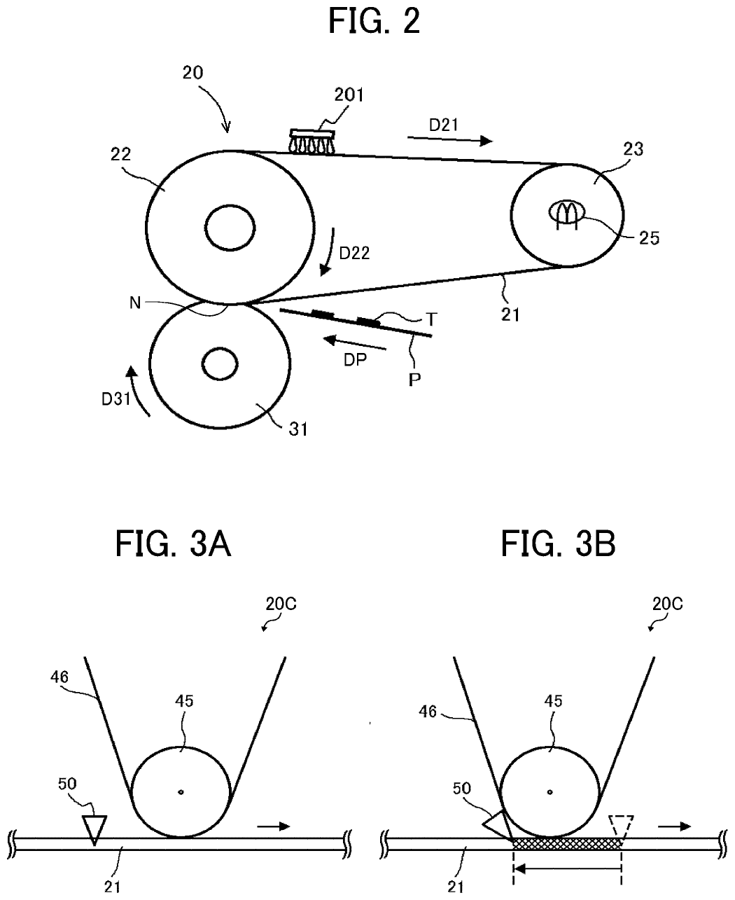

Referring to FIG. 2, a description is provided of a construction of the fixing device 20 incorporated in the image forming apparatus 1.

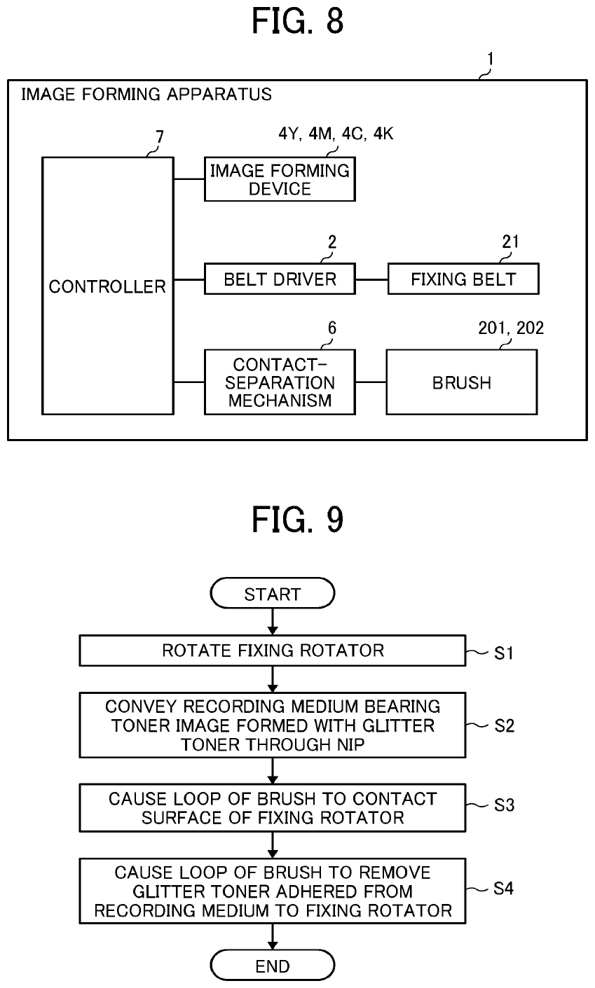

As illustrated in FIG. 2, the fixing device 20 according to an embodiment of the present disclosure employs a belt fixing method. The fixing device 20 includes a heating roller 23, the fixing belt 21 serving as a fixing rotator or a fixing member that is heated by the heating roller 23, a fixing roller 22, the pressure roller 31 serving as a pressure rotator or a pressure member, and a brush 201. The fixing device 20 further includes a belt driver 2 depicted in FIG. 8 and a pressurization mechanism. The belt driver 2 rotates the fixing belt 21 to convey a recording medium P. The pressurization mechanism applies pressure to the pressure roller 31, that presses the pressure roller 31 against the fixing belt 21, and releases the pressure. In the fixing device 20, as a recording medium P bearing a toner image T formed with at least the glitter toner passes through a fixing nip N formed between the fixing belt 21 and the pressure roller 31, the fixing belt 21 and the pressure roller 31 fix the toner image T on the recording medium P.

A description is provided of a construction of the fixing belt 21.

The fixing belt 21 serving as a fixing rotator or a fixing member is an endless belt having a multilayer structure in which an elastic layer is layered on a base layer and a release layer is layered on the elastic layer. The base layer is made of a polyimide resin and has a layer thickness of 90 μm. The elastic layer of the fixing belt 21 has a layer thickness of about 200 μm and is made of an elastic material such as silicone rubber, fluororubber, and silicone rubber foam. The release layer of the fixing belt 21 has a layer thickness of about 20 μm and is made of polytetrafluoroethylene perfluoroalkyl vinyl ether copolymer (PFA), polyimide, polyether imide, polyether sulfide (PES), or the like. The release layer serving as a surface layer of the fixing belt 21 facilitates separation and peeling of toner of the toner image T formed on the recording medium P from the fixing belt 21. The fixing belt 21 is stretched taut across and supported by a plurality of rollers, that is, the fixing roller 22 and the heating roller 23. The fixing belt 21 rotates in a rotation direction D21.

A description is provided of a construction of the fixing roller 22.

The fixing roller 22 is a tube having an outer diameter of 52 mm and includes a cored bar and an elastic layer disposed on the cored bar. The cored bar is made of stainless used steel (SUS) 304 or the like. The elastic layer is made of fluororubber, silicone rubber, silicone rubber foam, or the like and has a layer thickness of 14 mm according to this embodiment. The fixing roller 22 presses against the pressure roller 31 serving as a pressure rotator or a pressure member via the fixing belt 21 to form the fixing nip N between the fixing belt 21 and the pressure roller 31. The fixing roller 22 rotates in a rotation direction D22.

A description is provided of a construction of the heating roller 23.

The heating roller 23 is a tube made of metal such as aluminum. The tube has a thickness of 0.6 mm and an outer diameter of 35 mm. A heater 25 serving as a heat source is stationarily disposed inside the tube.

The heater 25 that heats the heating roller 23 is a halogen heater. Both lateral ends of the heater 25 in a longitudinal direction thereof are secured to frames of the fixing device 20, respectively. A power supply (e.g., an alternating current power supply) of the image forming apparatus 1 controls output of the heater 25. The heater 25 heats the heating roller 23 with radiant heat. The heating roller 23 heats the fixing belt 21. Heat is conducted from a surface of the fixing belt 21 heated by the heating roller 23 to the toner image T on the recording medium P. A controller 7 depicted in FIG. 8 controls output of the heater 25 based on a detection result provided by a thermopile incorporated in the fixing device 20. The thermopile is disposed opposite the surface of the fixing belt 21 without contacting the surface of the fixing belt 21 and detects the temperature of the surface of the fixing belt 21. For example, the heater 25 is applied with an alternating current (AC) voltage for a predetermined energization time that is determined based on the temperature of the fixing belt 21, that is detected by the thermopile. Such control of output of the heater 25 adjusts the temperature, that is, a fixing temperature, of the fixing belt 21 to a desired temperature (e.g., a target control temperature). Instead of the heater 25 disposed inside the heating roller 23, the fixing device 20 may employ an induction heating system in which an induction heater heats an outer circumferential surface of the fixing belt 21, a surface rapid fusing (SURF) system in which a resistive heat generator is disposed opposite the fixing nip N, or the like.

A description is provided of a construction of the pressure roller 31.

The pressure roller 31 serving as a pressure rotator or a pressure member includes a hollow, cored bar and an elastic layer disposed on the cored bar. The cored bar has a thickness of 1 mm. The elastic layer is made of silicone rubber, fluororubber, silicone rubber foam, or the like and has a layer thickness of 1.5 mm. The pressure roller 31 has an outer diameter of about 50 mm. Optionally, a thin release layer made of PFA or the like may be disposed on a surface of the elastic layer.

The pressurization mechanism coupled to the pressure roller 31 presses the pressure roller 31 against the fixing roller 22 via the fixing belt 21. Thus, the fixing nip N having a desired length in a recording medium conveyance direction DP is formed between the pressure roller 31 and the fixing belt 21. A driving motor disposed inside the image forming apparatus 1 drives and rotates the pressure roller 31 in a rotation direction D31.

Alternatively, the fixing device 20 according to this embodiment may incorporate a heater that heats the pressure roller 31 directly.

A description is provided of a construction of a first comparative fixing device.

In order to prevent degradation in gloss of toner images formed with the glitter toner when the toner images are fixed on recording media continuously, the first comparative fixing device includes a fixing member constructed of a base, an elastic layer disposed on the base, and a surface layer disposed on the elastic layer. The surface layer is made of tetrafluoroethylene perfluoroethyl vinyl ether copolymer. However, the glitter toner contains the glitter pigment made of flat rigid particles. If the flat rigid particles stick in a surface of the fixing member, the first comparative fixing device may not remove the flat rigid particles from the fixing member.

A description is provided of a construction of a second comparative fixing device.

The second comparative fixing device includes a fixing member and a fiber sheet made of non-woven fabric, felt, or the like. The fiber sheet slides over a surface of the fixing member to remove the glitter pigment from the fixing member. However, in a state in which the glitter pigment sticks in the surface of the fixing member, the fiber sheet slides over the fixing member with a linear velocity difference between the fixing member and the fiber sheet. Accordingly, scratches on the surface of the fixing member may spread in a rotation direction of the fixing member, thus increasing surface asperities and scratches on the surface of the fixing member.

FIGS. 3A and 3B illustrate a schematic view of a comparative fixing device 20C, illustrating a removal method for removing a glitter pigment 50 from the surface of the fixing belt 21.

FIG. 3A illustrates a state in which the glitter pigment 50 made of flat rigid particles remaining on the fixing belt 21 sticks in the fixing belt 21. The comparative fixing device 20C employing the removal method for removing the glitter pigment 50 includes a biasing member 45 and a slider 46. The biasing member 45 is a roller serving as a cleaner. The slider 46 is a sheet wound around the biasing member 45. FIG. 3A illustrates the biasing member 45 and the slider 46 that are pressed against the fixing belt 21 and halted. When the slider 46 removes the glitter pigment 50, the slider 46 that is halted drags the glitter pigment 50 over the fixing belt 21 as illustrated in FIG. 3B. Accordingly, the glitter pigment 50 may damage the fixing belt 21 as illustrated with shading in FIG. 3B. Consequently, the fixing belt 21 may degrade gloss of a toner image on a recording medium.

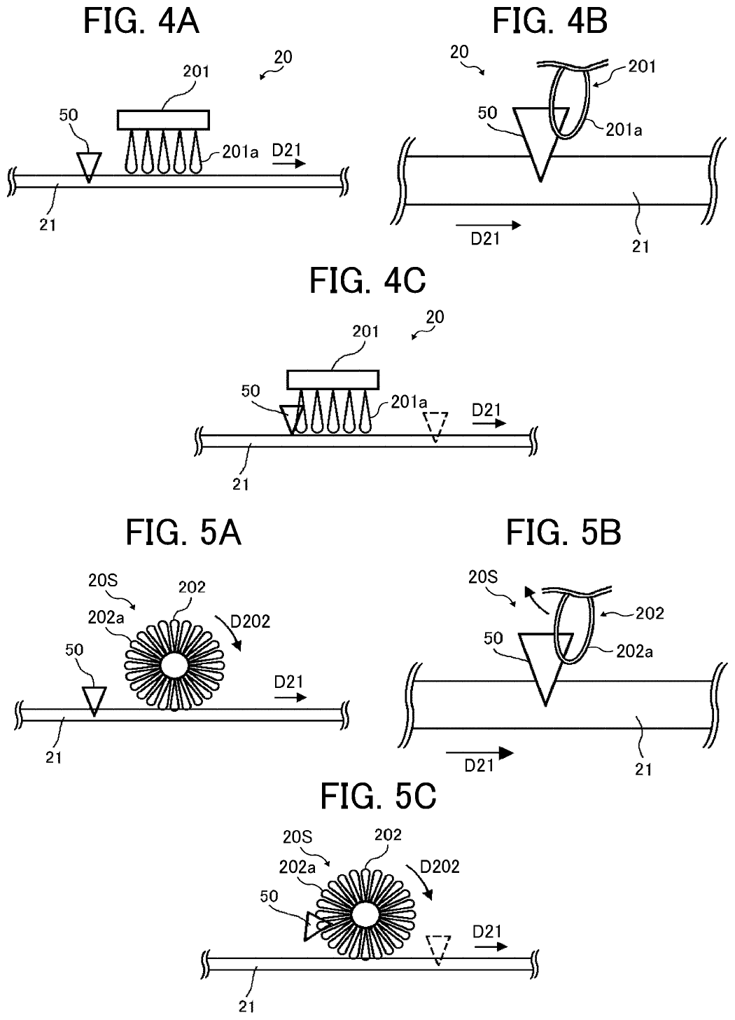

FIGS. 4A, 4B, and 4C illustrate a schematic view of the fixing device 20 according to a first embodiment of the present disclosure. FIGS. 4A, 4B, and 4C illustrate a removal method for removing the glitter pigment 50 from the surface of the fixing belt 21 of the fixing device 20 according to the first embodiment of the present disclosure.

As illustrated in FIG. 4A, the fixing device 20 according to the first embodiment further includes a brush 201 including loops 201a mounted on a front end of the brush 201, that is, an opposed face of the brush 201, that is disposed opposite the fixing belt 21. The brush 201, serving as a cleaner, contacts the surface of the fixing belt 21 in which the glitter pigment 50 made of flat rigid particles remaining on the fixing belt 21 sticks. As the brush 201 including the loops 201a mounted on the opposed face of the brush 201 contacts the surface of the fixing belt 21, the loop 201a mounted on the opposed face of the brush 201 catches an edge of the glitter pigment 50 as illustrated in FIG. 4B. The loop 201a pulls the glitter pigment 50 out of the fixing belt 21 without dragging the glitter pigment 50 over the fixing belt 21 as illustrated in FIG. 4C.

Thus, the brush 201 removes the glitter pigment 50 from the surface of the fixing belt 21. The brush 201 removes the glitter pigment 50 without increasing surface asperities and scratches on the fixing belt 21, cleaning the surface of the fixing belt 21. Accordingly, the brush 201 prevents the glitter pigment 50 from damaging the surface of the fixing belt 21, suppressing failures such as degradation in gloss of the toner image T on the recording medium P.

According to the embodiments of the present disclosure, a brush (e.g., the brush 201) defines a member including a handle, a plate, a shaft, or the like implanted with a plurality of strands of animal hair, plant fiber, a synthetic resin, or the like.

A loop (e.g., the loop 201a) defines a ring made of a material such as the synthetic resin like pile fabric.

FIGS. 5A, 5B, and 5C illustrate a schematic view of a fixing device 20S according to a second embodiment of the present disclosure.

As illustrated in FIG. 5A, the fixing device 20S according to the second embodiment includes a brush 202 that is rotatable. For example, the brush 202 is a tube that is rotatable. The brush 202 includes loops 202a mounted on an opposed face (e.g., a front end) of the brush 202, that is disposed opposite the fixing belt 21. The brush 202, serving as a cleaner, contacts the surface of the fixing belt 21 in which the glitter pigment 50 made of the flat rigid particles remaining on the fixing belt 21 sticks. As the brush 202 that is rotatable contacts the surface of the fixing belt 21, the loop 202a mounted on the opposed face of the brush 202 catches the edge of the glitter pigment 50 as illustrated in FIG. 5B. The loop 202a pulls the glitter pigment 50 out of the fixing belt 21 without dragging the glitter pigment 50 over the fixing belt 21 as illustrated in FIG. 5C. Thus, the brush 202 removes the glitter pigment 50 from the surface of the fixing belt 21. The brush 202 removes the glitter pigment 50 without increasing surface asperities and scratches on the fixing belt 21, cleaning the surface of the fixing belt 21. Additionally, as the brush 202 rotates, the loops 202a mounted on the opposed face of the brush 202 rotate while contacting the surface of the fixing belt 21 continuously, thus maintaining cleaning performance of the brush 202 for an extended period of time.

The loops 202a mounted on the opposed face of the brush 202 rotate in a rotation direction D202, that is, a counter direction opposite the rotation direction D21 of the fixing belt 21. Accordingly, the loops 202a mounted on the opposed face of the brush 202 contact the surface of the fixing belt 21 for an increased time per unit time, cleaning the fixing belt 21 efficiently.

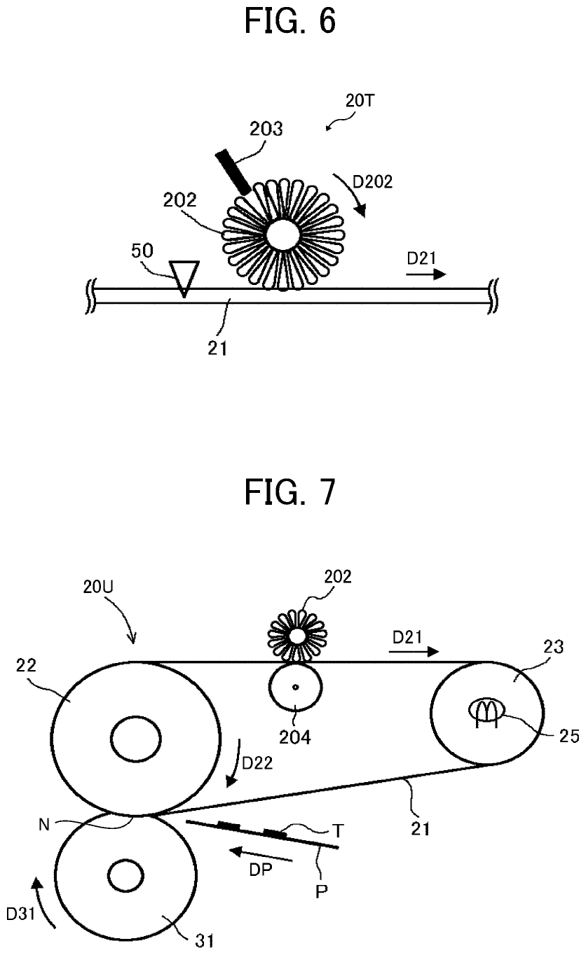

FIG. 6 is a schematic view of a fixing device 20T according to a third embodiment of the present disclosure.

As illustrated in FIG. 6, the fixing device 20T according to the third embodiment includes a cleaner 203 that contacts the brush 202 and removes a foreign substance adhered to the brush 202 therefrom. For example, the cleaner 203 is a blade or a plate. As the cleaner 203 contacts the brush 202, the cleaner 203 removes the foreign substance such as the glitter pigment 50 removed from the fixing belt 21 from the brush 202. Accordingly, the cleaner 203 retains the loops 202a mounted on the opposed face of the brush 202 to be clean, thus maintaining cleaning performance of the brush 202 for an extended period of time.

FIG. 7 is a schematic view of a fixing device 20U according to a fourth embodiment of the present disclosure.

As illustrated in FIG. 7, the fixing device 20U according to the fourth embodiment includes a backup member 204. The fixing belt 21 serving as a fixing rotator or a fixing member is a belt, not a roller, for example. The backup member 204, serving as a support, is disposed opposite the brush 202 via the fixing belt 21. The backup member 204 stabilizes an orbit of rotation of the fixing belt 21 at a cleaning position where the brush 202 contacts and cleans the fixing belt 21. Alternatively, in the fixing device 20 depicted in FIGS. 2, 4A, 4B, and 4C, the backup member 204, serving as a support, may be disposed opposite the brush 201, serving as a cleaner that does not rotate, via the fixing belt 21.

If the fixing belt 21 is used as a fixing rotator or a fixing member, the fixing belt 21 may flap at a position where no support contacts an inner circumferential surface of the fixing belt 21. Accordingly, an amount of engagement of the brush 202 that engages the fixing belt 21 may change. Consequently, the brush 202 may not contact and clean the fixing belt 21. Conversely, the brush 202 may engage the fixing belt 21 excessively, damaging the fixing belt 21. To address this circumstance, the fixing device 20U includes the backup member 204 that contacts the inner circumferential surface of the fixing belt 21. Accordingly, the backup member 204 stabilizes the orbit of rotation of the fixing belt 21 at the cleaning position where the brush 202 contacts and cleans the fixing belt 21. Consequently, the backup member 204 causes the brush 202 to remove the glitter pigment 50 from the fixing belt 21 and clean the fixing belt 21 properly and constantly.

The image forming apparatus 1 according to the embodiments of the present disclosure includes the fixing device 20, 20S, 20T, or 20U. Accordingly, even if the image forming apparatus 1 uses the glitter toner containing the glitter pigment 50, the image forming apparatus 1 maintains proper quality of the toner image T on the recording medium P for an extended period of time.

Referring to FIGS. 8 and 9, a description is provided of a fixing method performed by the fixing devices 20, 20S, 20T, and 20U according to the first, second, third, and fourth embodiments of the present disclosure, respectively.

FIG. 8 is a block diagram of the image forming apparatus 1. FIG. 9 is a flowchart illustrating processes of the fixing method.

As illustrated in FIGS. 8 and 9, in step S1, the controller 7 controls the belt driver 2 to rotate the fixing belt 21 serving as a fixing rotator or a fixing member in the rotation direction D21.

In step S2, a recording medium P bearing a toner image T formed with glitter toner (e.g., the glitter pigment 50) is conveyed through the fixing nip N, serving as a nip, formed between the fixing belt 21 and the pressure roller 31 serving as a pressure rotator or a pressure member so that the fixing belt 21 and the pressure roller 31 fix the toner image T on the recording medium P.

In step S3, the controller 7 controls a contact-separation mechanism 6 to cause the loops 201a or 202a mounted on the opposed face of the brush 201 or 202 to contact the surface of the fixing belt 21.

In step S4, the loops 201a or 202a of the brush 201 or 202 remove the glitter toner adhered from the recording medium P to the fixing belt 21 from the fixing belt 21.

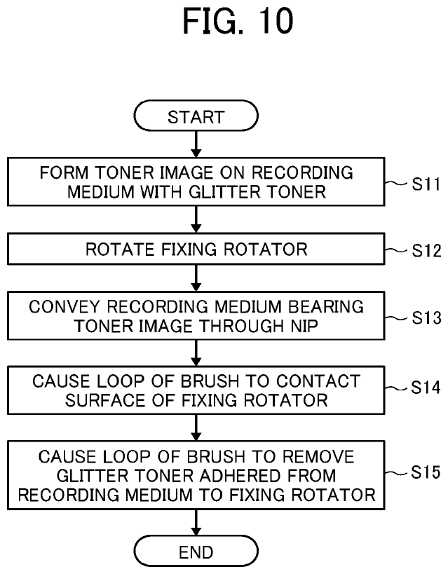

Referring to FIGS. 8 and 10, a description is provided of an image forming method performed by the image forming apparatus 1 according to the embodiments of the present disclosure.

FIG. 10 is a flowchart illustrating processes of the image forming method.

As illustrated in FIGS. 8 and 10, in step S11, the controller 7 controls the image forming devices 4Y, 4M, 4C, and 4K to form a toner image T with glitter toner (e.g., the glitter pigment 50) on a recording medium P.

In step S12, the controller 7 controls the belt driver 2 to rotate the fixing belt 21 serving as a fixing rotator or a fixing member in the rotation direction D21.

In step S13, the recording medium P bearing the toner image T is conveyed through the fixing nip N, serving as a nip, formed between the fixing belt 21 and the pressure roller 31 serving as a pressure rotator or a pressure member so that the fixing belt 21 and the pressure roller 31 fix the toner image T on the recording medium P.

In step S14, the controller 7 controls the contact-separation mechanism 6 to cause the loops 201a or 202a mounted on the opposed face of the brush 201 or 202 to contact the surface of the fixing belt 21.

In step S15, the loops 201a or 202a of the brush 201 or 202 remove the glitter toner adhered from the recording medium P to the fixing belt 21 from the fixing belt 21.

As described above, if a glitter pigment (e.g., the glitter pigment 50) made of flat rigid particles contained in glitter toner sticks in a surface of a fixing rotator (e.g., the fixing belt 21), a general stationary cleaner may drag the glitter pigment over the fixing rotator, damaging the fixing rotator. Conversely, according to the embodiments of the present disclosure, a cleaner, for example, a brush (e.g., the brushes 201 and 202) including loops (e.g., the loops 201a and 202a) mounted on an opposed face of the brush, that is disposed opposite the fixing rotator, contacts the surface of the fixing rotator. The brush pulls the glitter pigment, that is made of the flat rigid particles and sticks in the surface of the fixing rotator, out of the fixing rotator without dragging the glitter pigment over the fixing rotator. Thus, the brush removes the glitter pigment from the surface of the fixing rotator without increasing surface asperities and scratches on the fixing rotator, thus cleaning the surface of the fixing rotator.

A description is provided of advantages of a fixing device (e.g., the fixing devices 20, 20S, 20T, and 20U).

As illustrated in FIGS. 2 and 7, the fixing device includes a fixing rotator (e.g., the fixing belt 21), a pressure rotator (e.g., the pressure roller 31), and a brush (e.g., the brushes 201 and 202).

As a recording medium (e.g., the recording medium P) bearing a toner image (e.g., the toner image T) formed with glitter toner is conveyed through a nip (e.g., the fixing nip N) formed between the fixing rotator and the pressure rotator, the fixing rotator and the pressure rotator fix the toner image on the recording medium. The brush includes a loop (e.g., the loops 201a and 202a) mounted on an opposed face of the brush, that is disposed opposite the fixing rotator. The loop of the brush contacts a surface of the fixing rotator.

Accordingly, when the fixing device fixes the toner image formed with the glitter toner on the recording medium, the brush prevents the glitter toner from damaging the fixing rotator, maintaining a proper condition of the fixing rotator for an extended period of time and retaining improved quality of the toner image on the recording medium.

According to the embodiments described above, the fixing belt 21 serves as a fixing rotator. Alternatively, a fixing film, a fixing sleeve, or the like may be used as a fixing rotator. Further, the pressure roller 31 serves as a pressure rotator. Alternatively, a pressure belt or the like may be used as a pressure rotator.

According to the embodiments described above, the image forming apparatus 1 is a printer. Alternatively, the image forming apparatus 1 may be a copier, a facsimile machine, a multifunction peripheral (MFP) having at least two of printing, copying, facsimile, scanning, and plotter functions, an inkjet recording apparatus, or the like.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A fixing device comprising:
a fixing rotator configured to rotate in a rotation direction;
a pressure rotator configured to press against the fixing rotator to form a nip between the fixing rotator and the pressure rotator, the nip through which a recording medium bearing a toner image formed with glitter toner is conveyed; and
a brush including a loop configured to contact a surface of the fixing rotator.

2. The fixing device according to claim 1,
wherein the loop is mounted on an opposed face of the brush, the opposed face disposed opposite the fixing rotator.

3. The fixing device according to claim 1,
wherein the brush is configured to rotate.

4. The fixing device according to claim 3,
wherein the brush is configured to rotate in a counter direction opposite the rotation direction of the fixing rotator.

5. The fixing device according to claim 3, further comprising a cleaner configured to contact the brush and remove a foreign substance adhered to the brush from the brush.

6. The fixing device according to claim 5,
wherein the cleaner includes one of a blade and a plate.

7. The fixing device according to claim 1,
wherein the fixing rotator includes a belt.

8. The fixing device according to claim 7, further comprising a support disposed opposite the brush via the belt.

9. An image forming apparatus comprising the fixing device according to claim 1.

10. A fixing method comprising:
rotating a fixing rotator;
conveying a recording medium bearing a toner image formed with glitter toner through a nip formed between the fixing rotator and a pressure rotator;
causing a loop of a brush to contact a surface of the fixing rotator; and
causing the loop of the brush to remove the glitter toner adhered from the recording medium to the fixing rotator from the fixing rotator.

11. An image forming method comprising:
forming a toner image on a recording medium with glitter toner;
rotating a fixing rotator;
conveying the recording medium bearing the toner image through a nip formed between the fixing rotator and a pressure rotator;
causing a loop of a brush to contact a surface of the fixing rotator; and
causing the loop of the brush to remove the glitter toner adhered from the recording medium to the fixing rotator from the fixing rotator.
